(19) United States
(12) Patent Application Publication
(10) Pub. No.: US 2016/0039345 A1
(43) Pub. Date: Feb. 11, 2016

(54) ANTI-SKID STRUCTURE

(71) Applicant: Caterpillar SARL, Geneva (CH)

(72) Inventors: Abhishek K. Mishra, Chennai (IN); Antony G. Joseph, Chennai (IN)

(73) Assignee: Caterpillar SARL, Geneva (CH)

(21) Appl. No.: 14/887,340

(22) Filed: Oct. 20, 2015

(51) Int. Cl. B60R 3/00

(52) U.S. Cl. CPC B60R 3/005; B60R 3/002

(57) ABSTRACT

An anti-skid structure is provided. The anti-skid structure includes a mounting plate having a surface, a first length and a second length, with a plurality of projections embossed on the surface of the mounting plate. Each of the plurality of projections includes a frustum structure, and a cylindrical structure on a top of the frustum structure. A distance between each projection of the plurality of projections, and an adjacent projection of the plurality of projections, along each of the first direction and the second direction is 44 mm.

### TECHNICAL FIELD

The present disclosure relates to an anti-skid structure, and more specifically, to an anti-skid structure having an optimal pitch distance.

### BACKGROUND

Heavy machines such as hydraulic excavators typically have walkway platforms to facilitate a user to reach different access points for daily maintenance activities. These walkway platforms are well above the ground level and, depending on the weather and the working environment, are exposed to dry, wet, or muddy conditions. The walkway platforms are desired to provide a non-slippery surface for better safety of the operators. Typically, the walkway platforms are provided with projections embossed on a metal plate.

Currently, projections are formed by punching the metal plate, using turret machines with a specialized tool. The parts of the specialized tool are expensive, and need regular maintenance and/or complete replacement after certain number of punches. Therefore, it is desirable to minimize the number of punches, without compromising the anti-skid properties of the walkway platforms.

United States Publication Number 2006/0272229 relates to an anti-slipping board. The anti-slipping board has a flat plate, which is provided with a plurality of protruded rounded floating bodies having a rounded protrusion at a center of each of the floating bodies. The anti-slipping board is preferably made from metallic material or ceramic material, and the floating bodies and the rounded projections are formed by casting or formed as one unit. A distance between the centers of each floating body is 47 mm. However, such an anti-slipping board may be costly to manufacture and does not provide desired anti-skid properties.

### SUMMARY OF THE DISCLOSURE

In one aspect of the present disclosure, an anti-skid structure is provided. The anti-skid structure includes a mounting plate having a surface, a first length along a first direction and a second length along a second direction. Further, a plurality of projections is embossed on the surface of the mounting plate. Each of the plurality of projections includes a frustum structure, and a cylindrical structure on top of the frustum structure. A distance between each projection of the plurality of projections, and an adjacent projection of the plurality of projections, along each of the first direction and the second direction is 44 mm.

Other features and aspects of this disclosure will be apparent from the following description and the accompanying drawings.

### BRIEF DESCRIPTION OF THE DRAWINGS

FIG. 1 is a side view of a hydraulic excavator to which an anti-skid structure of the present disclosure is applied, in accordance with the concepts of the present disclosure;

FIG. 2 is a perspective view of the anti-skid structure in accordance with the concepts of the present disclosure;

FIG. 3 is a perspective view of the anti-skid structure along with a detailed view of a projection of a plurality of projections on a mounting plate of the anti-skid structure in accordance with the concepts of the present disclosure;

FIG. 4 is a sectional view taken along 4-4 of FIG. 3 of the projection of the plurality of projections on the mounting plate of the anti-skid structure in accordance with the concepts of the present disclosure; and

FIG. 5 is a top view of the anti-skid structure in accordance with the concepts of the present disclosure.

### DETAILED DESCRIPTION

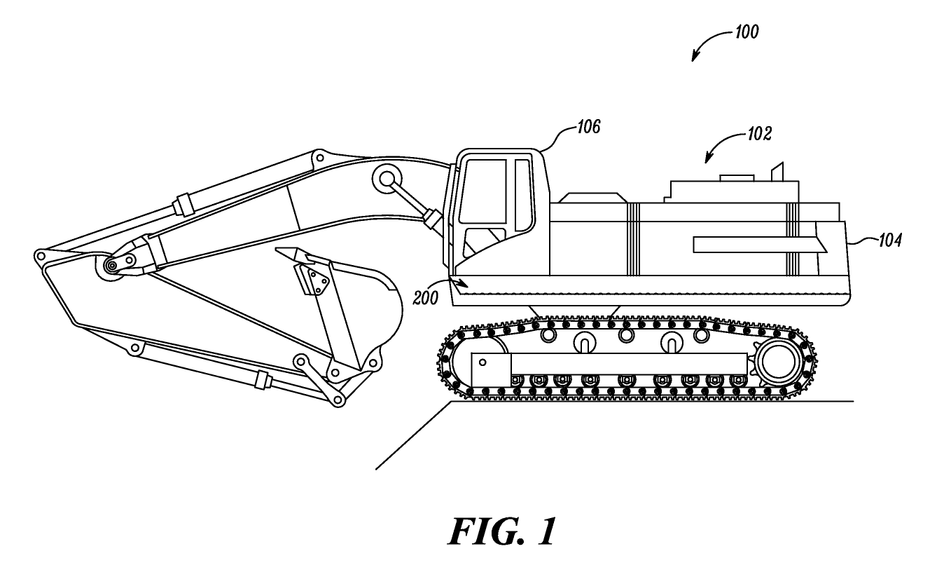

FIG. 1 is a side view of a hydraulic excavator 100, in accordance with the concepts of the present disclosure. The hydraulic excavator 100 includes a rotatable superstructure 102, a plurality of counterweights 104, a cabin 106, and an anti-skid structure 200. For the purpose of simplicity, the various components of the hydraulic excavator 100 are not labeled in FIG. 1. Various components of the hydraulic excavator 100 may require timely maintenance to ensure proper functioning, for example, an engine (not shown) included in the rotatable superstructure 102 may require maintenance. The counterweights 104 and a door of the cabin 106 may also require timely maintenance or regular cleaning. Typically, for this purpose, the anti-skid structure 200 is utilized by a user to reach different access points for regular maintenance of the various components of the hydraulic excavator 100. The user may be a worker, an operator, or maintenance personnel. The anti-skid structure 200 provides a non-slippery surface to the user to ensure better safety of the user, otherwise the user may fall while cleaning the door of the cabin 106, or the user may slip while walking on the anti-skid structure 200.

In this embodiment, the anti-skid structure 200 is shown outside the cabin 106 of the hydraulic excavator 100 in a horizontal direction. It should be noted that the anti-skid structure 200 may be placed/fastened in another direction as well, such as inclined at a particular angle with the ground, without departing from the scope of the disclosure.

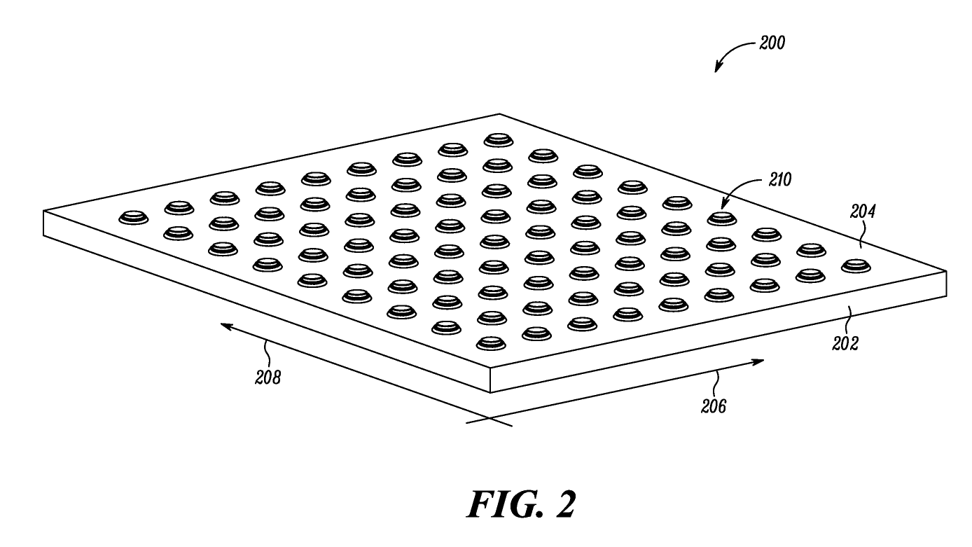

FIG. 2 is a perspective view of the anti-skid structure 200 in accordance with the concepts of the present disclosure. The anti-skid structure 200 includes a mounting plate 202, having a surface 204, a first length along a first direction 206 and a second length along a second direction 208. The mounting plate 202 further includes a number of projections 210 embossed on the surface 204 of the mounting plate 202. The shape of the mounting plate 202 includes, but not limited to, a square, a rectangle, a rhombus, a parallelogram and a trapezium. In accordance with an embodiment, a material of construction of the mounting plate 202 includes, but not limited to, iron, aluminum, copper, steel, and any other metal or alloy.

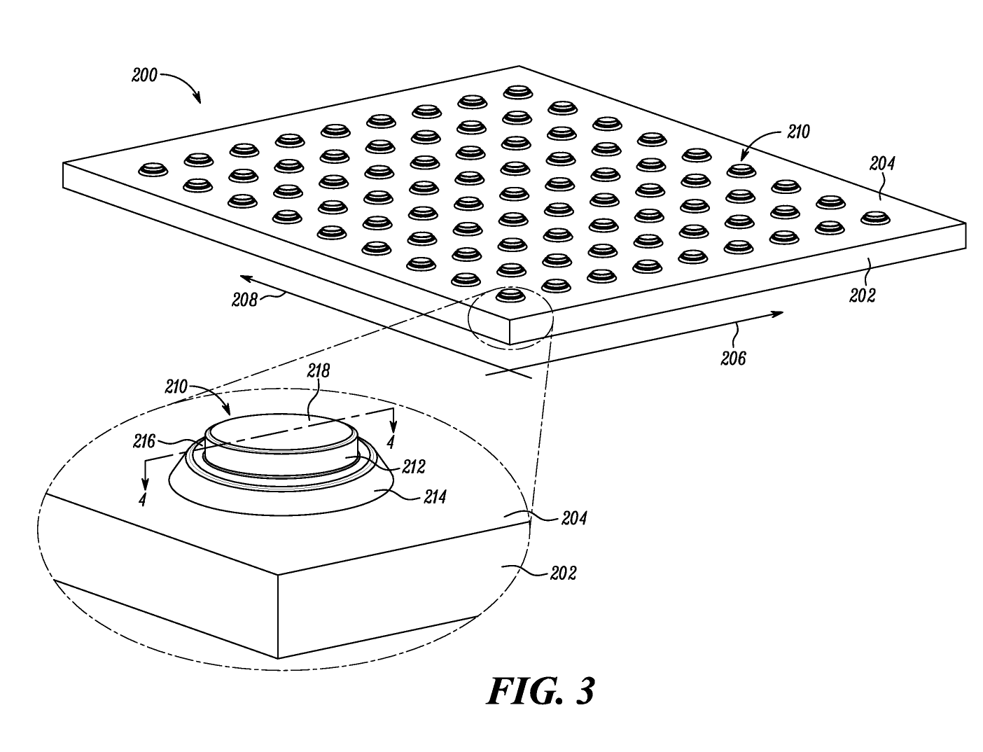

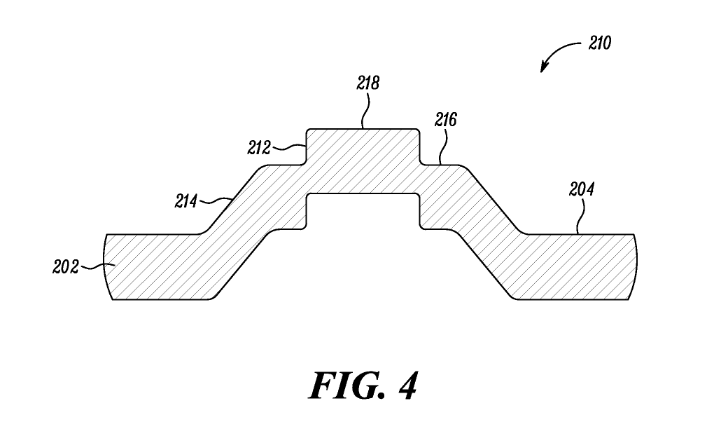

Referring to FIG. 3 and FIG. 4, a perspective view of the anti-skid structure 200 along with a detailed view of a projection 210 and a sectional view of the projection 210 taken along 4-4 of FIG. 3 is shown. The projections 210 are uniformly distributed on the mounting plate 202. Further, the projections 210 on the mounting plate 202 include a frustum structure 214 having a top surface 216. A cylindrical structure 212 is present on the top surface 216 of the frustum structure 214. The cylindrical structure 212 further includes a top surface 218, which is substantially flat.

In an embodiment of the present disclosure, the anti-skid structure 200 is provided in the hydraulic excavator 100 of FIG. 1. A user may stand on the anti-skid structure 200, and access various components of the hydraulic excavator 100 for carrying out maintenance activities. In such a situation, the projections 210 are configured to provide an optimal friction between the shoes worn by the user and the anti-skid structure 200, while climbing in and out of the hydraulic excavator 100. The cylindrical structure 212 and the frustum structure 214 engage with the shoes worn by the user and enhance friction between the shoes and the mounting plate 202, thereby, enhancing the safety of the user.

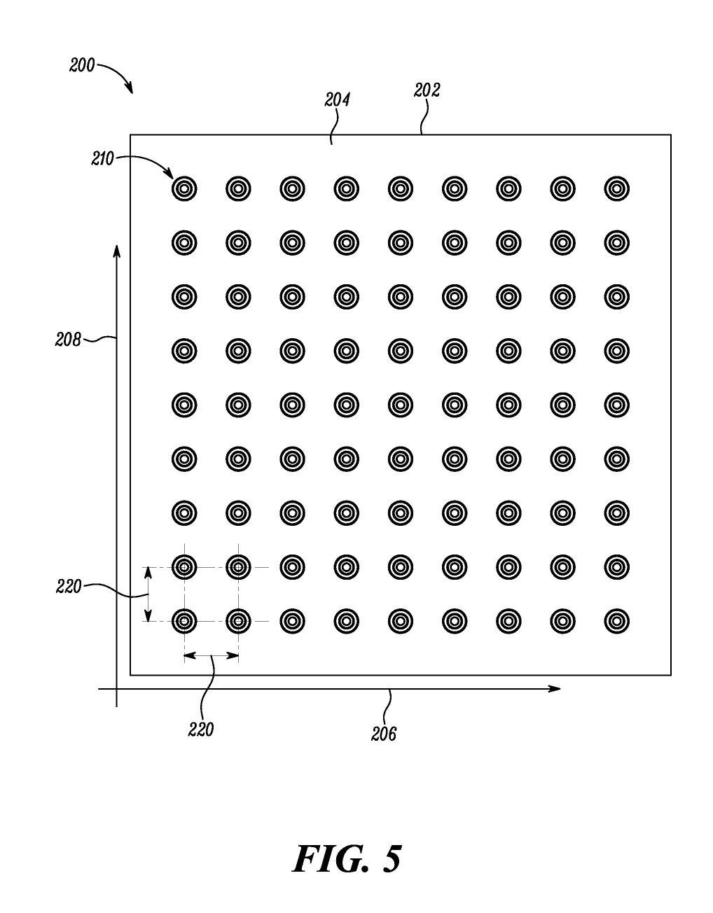

FIG. 5 is a top view of the anti-skid structure 200 in accordance with the concepts of the present disclosure. A pitch distance 220 is shown, which is calculated as center to center distance between two adjacent projections 210 of the anti-skid structure 200, along each of the first direction 206 and the second direction 208. In this embodiment, the projections 210 are provided at the pitch distance 220 of 44 mm. The pitch distance 220 of 44 mm, along with the shape of the projections 210 (explained above in conjunction with FIG. 3 and FIG. 4), provides improved anti-slip properties to the anti-skid structure 200, thereby, providing better friction between the shoes of the user and the walkway platform of the machine and which in turn enhances safety of the user.

Referring to FIG. 1, the anti-skid structure 200 in accordance with the concepts of the present disclosure is shown in the hydraulic excavator 100. However, the anti-skid structure 200 may be provided in walkway platforms of other machines, such as, but not limited to, a motor grader, a dozer, a haul truck, and an articulated truck. Alternatively, the anti-skid structure 200 may be provided in other equipments such as, but not limited to, a travelator, a ramp, and an escalator.

Although, in FIG. 1, the anti-skid structure 200 is shown parallel to horizontal surface, it will be apparent to one skilled in the art that the anti-skid structure 200 may be provided at an angle with respect to horizontal surface, or during actual working conditions, the hydraulic excavator 100 may be inclined at an angle to the horizontal surface, making the anti-skid structure 200 inclined at an angle with respect to horizontal surface. Even in such situations, the anti-skid structure 200 is configured to provide an optimal friction, and hence, improved safety to the user.

### INDUSTRIAL APPLICABILITY

In a hydraulic excavator, there are several walkways including platforms to facilitate a user to reach different access points for daily maintenance activities. These walkway platforms are well above the ground level on the hydraulic excavator and are open to the sky, which results in different surface conditions of the walkway platforms, for example, dry, wet or muddy, depending on the working conditions. In all conditions, the walkway platform should be safe and provide sufficient friction between the surface of walkway platform and the shoes of a user.

Typically, the walkway platforms are provided with projections embossed on metal plates, manufactured by embossing the projections on the metal plate using turret machines, with a specialized tool. The parts of the specialized tool are expensive, and need regular maintenance and complete replacement after certain number of punches.

The present disclosure provides the anti-skid structure 200 including the projections 210 embossed on the surface 204 of the mounting plate 202. The projections 210 have a pitch distance 220 of 44 mm, which provides improved anti-slip properties to the anti-skid structure 200, thereby, enhancing the safety of the user. Also, the pitch distance 220 of 44 mm reduces the overall number of the projections 210 to be embossed per square area of the mounting plate 202, thereby reducing the cost of manufacturing of the anti-skid structure 200. Further, the shape of the projections 210 allows sand, gravel or mud to be easily discharged, by injecting high pressure water or air thereby, simplifying the cleaning and/or maintenance process for the anti-skid structure 200.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An anti-skid structure comprising:
a mounting plate having a surface, a first length along a first direction and a second length along a second direction; and
a plurality of projections embossed on the surface of the mounting plate, the plurality of projections comprising:
a frustum structure; and
a cylindrical structure on a top of the frustum structure, wherein a distance between each projection of the plurality of projections, and an adjacent projection of the plurality of projections, along each of the first direction and the second direction is 44 mm.
